(19) United States
(12) Patent Application Publication
(10) Pub. No.: US 2026/0060245 A1
(43) Pub. Date: Mar. 5, 2026

(54) BIODEGRADABLE INSECT CONTROL MEDIUM

(71) Applicant: MosGone LLC, Austin, TX (US)

(72) Inventors: Kyle Boureston, Austin, TX (US); Hugo Miguel Lisboa Oliveira, Campina Grande (BR); Bárbara Loureiro, Vila Velha (BR)

(21) Appl. No.: 19/258,720

(22) Filed: Jul. 2, 2025

Related U.S. Application Data
(60) Provisional application No. 63/668,687, filed on Jul. 8, 2024.

(51) Int. Cl. A01N 25/34; A01N 65/28; A01N 65/42; A01P 7/04

(52) U.S. Cl. CPC A01N 25/34; A01N 65/28; A01N 65/42; A01P 7/04

(57) ABSTRACT

The present disclosure relates to a biodegradable insect control medium comprised of, in some embodiments, two types of delivery mediums such as a first tablet having insecticidal active ingredients, a second tablet having oviposition influencing ingredients, and, the tablets, in combination, creating a desirable and effective insect lifecycle control method when the tablets are introduced into a body of water.

### FIELD OF THE INVENTION

The present invention relates to insect control. More specifically, the present invention relates to an ovicidal and/or larvicidal control medium comprising a biodegradable medium (often in the form of a tablet) that releases at least one oil and at least one agent having oviposition-attracting and/or oviposition-deterrent-masking properties into a body of water targeting aquatic or semi-aquatic insects.

### BACKGROUND OF THE INVENTION

Mosquitoes are vectors for many deadly diseases, including malaria, dengue fever, Zika virus, and West Nile virus, posing significant health risks worldwide. Traditional pest, insect, and/or mosquito control methods have primarily involved chemical insecticides, biological control agents, and physical preventive measures like nets and traps. However, these methods often come with drawbacks such as low efficiency, environmental pollution, toxic effects on non-target species, and the development of resistance among mosquito populations. Chemical insecticides, while effective, can contaminate water sources and negatively impact biodiversity by harming beneficial insects, aquatic life, and birds. Biological control methods, such as introducing predators or competitors, require careful ecological consideration to avoid unintended consequences. Physical barriers and repellents provide personal protection but do not address the root problem of mosquito breeding. Accordingly, a need exists for an insect or mosquito control medium that is effective, environmentally friendly, and easy to deploy in small water bodies.

Essential oils and cold-pressed oils (collectively “oils”) are known for their insecticidal properties and minimal environmental impact. Further, certain oils within these classes of oils are particularly well suited for their ovicidal and/or larvicidal mechanisms. Some of the compounds found in these oils, such as monoterpenoids, sesquiterpenoids, and phenolics, can penetrate the eggshell or larval cuticle and can disrupt vital cellular functions, such as enzyme activity and membrane integrity, leading to cell death. Some of these oils can inhibit the respiratory system of mosquito larvae by disrupting the normal functioning of the mitochondria, leading to a decrease in ATP production, causing energy depletion and eventually the death of the larvae. Additionally, certain compounds in within these oils, such as thymol in thyme oil and menthol in peppermint oil, can interfere with the normal functioning of the nervous system by binding to neural receptors, causing hyperactivity or paralysis, leading to the death of the larvae. Essential oils may also act as insect growth regulators by mimicking or inhibiting juvenile hormones, which are crucial for the development and metamorphosis of mosquito larvae. The sesquiterpenoids in cedarwood oil, for instance, can interfere with the hormonal balance, preventing the larvae from developing into pupae and then into adult mosquitoes. Furthermore, essential oils can increase the permeability of cell membranes, leading to the leakage of essential ions and other cellular components, resulting in cell lysis and death. Terpenes like limonene in citrus oils can cause such effects, leading to the disintegration of egg or larval tissues. Some essential oils induce oxidative stress in mosquito larvae by generating reactive oxygen species, which can damage cellular components such as lipids, proteins, and DNA, leading to cellular dysfunction and death. Compounds like carvacrol in oregano oil have been shown to induce oxidative stress in insect larvae. Some essential oils may damage or kill the eggs or larvae upon contact (also referred to as “contact killing”) while others require ingestion.

Despite the proven effectiveness and natural ecological friendliness, a significant challenge in using essential oils or cold-pressed oils (any oil possibly being natural or synthetic) as ovicides, larvicides, adulticides, or, collectively, pesticides has been the effective delivery of these oils in a controlled manner that ensures prolonged effectiveness and minimal risk to humans. Thus, there is a considerable gap in the market for a biodegradable insect control medium that combines efficacy, environmental safety, and ease of use.

One of the significant challenges with using these oils in mosquito control is their oviposition deterrent effect on gravid female mosquitoes. Given that essential oil and cold-pressed oil treated water often deter oviposition, they are limited in their pesticidal capabilities to a one-time treatment, and this may render these oils ineffective as lasting ovicidal and larvicidal agents. Another challenge is that essential oils and cold-pressed oils are not water-soluble, which causes these oils to pool and restrict their ovicidal and larvicidal efficacies within those pooled-oil locations. Another challenge is related to the volatility of these oils yielding them ineffective after a short time and thus limiting their long-term action.

There is an urgent need for innovative solutions that target mosquitoes at their source—primarily water bodies where they breed—without the negative impacts associated with traditional pesticide methods. The ideal solution would be sustainable, environmentally friendly, minimally oviposition deterring, and specifically targeted to disrupt the aquatic or semi-aquatic insect (like mosquitoes) lifecycle at the egg or larval stage before the insects mature into disease-carrying adults. The development of an ovicidal and larvicidal lifecycle control mechanism that is biodegradable and utilizes essential oils or cold-pressed oils presents a promising alternative to traditional pest, insect, and mosquito control methods. The present invention aims to fill the gap in the market by introducing a novel insect pesticidal tablet that minimally deters species like mosquitoes from laying their eggs in a treated body of water, where emerging larvae will be exposed to lethal concentrations of the aforementioned oils, effectively disrupting the mosquito lifecycle in a highly effective, eco-friendly, and sustainable manner. The present invention addresses typical issues surrounding the use of these oils by encapsulating these oils using various natural encapsulating agents and, sometimes, by using synergistic blends of essential oils. The encapsulation method ensures that these oils are dispersed as micro-droplets and homogenized in water, reducing their detectability to female mosquitoes at the water surface, and reducing the oil's volatility. The synergistic blend of these oils yields a high ovicidal and/or larvicidal efficacy at substantially lower total oil concentrations than seen in traditional methods. These innovations are crucial as they allow these oils to act as effective ovicides and/or larvicides with minimal deterrence to mosquitoes laying their eggs in the treated water.

### SUMMARY OF THE INVENTION

The following presents a simplified summary of the present invention to provide a basic understanding of the invention's concepts. This summary is not an extensive overview, and it is not intended to identify critical elements or to limit the scope of this discloser. The sole purpose of this summary is to present some general concepts in a simplified form as a prelude to the detailed description of the invention.

The subject matter disclosed and claimed herein, in one embodiment of the present invention, comprises a biodegradable insect control medium comprising a first tablet comprised of at least one encapsulation agent which encapsulates at least one active ingredient; a second tablet comprised of at least one oviposition influencing agent; wherein the at least one active ingredient includes at least one insecticidal oil; wherein the first tablet is designed to release the at least one active ingredient into a body of water by the body of water's effect on the encapsulation agent; wherein the second tablet is designed to release the at least one oviposition influencing agent into the body of water; and wherein the first tablet and the second tablet are placed into the body of water so that the second tablet influences oviposition of female insects while the first tablet disrupts the species of insect's lifecycle by causing at least one desired effect from ovicide and larvicide.

In an alternative embodiment, the present invention comprises a biodegradable insect control medium comprising at least two delivery mediums; wherein at least one of the delivery mediums is a first medium comprised of at least one encapsulation agent which encapsulates at least one active ingredient; wherein at least one of the delivery mediums is a second medium comprised of at least one oviposition influencing agent; wherein the at least one active ingredient includes at least one insecticidal oil; wherein the first medium is designed to release the at least one active ingredient into a body of water by the body of water's effect on the encapsulation agent; wherein the second medium is designed to release the at least one oviposition influencing agent into the body of water; and wherein the first medium and the second medium are placed into the body of water so that the second medium influences oviposition of female insects while the first medium disrupts the species of insect's lifecycle by causing at least one desired effect from ovicide and larvicide.

In an alternative embodiment, the present invention comprises a biodegradable insect control medium comprising a delivery medium comprised of at least one encapsulation agent which encapsulates at least one active ingredient; wherein the at least one active ingredient includes at least one insecticidal oil; wherein the delivery medium is designed to release the at least one active ingredient into a body of water by the body of water's effect on the encapsulation agent; and wherein the delivery medium is placed into the body of water so that the delivery medium disrupts the species of insect's lifecycle by causing at least one desired effect from ovicide and larvicide.

To the accomplishment of the foregoing and related ends, certain illustrative aspects of the disclosed innovation are described herein in connection with the following description and the annexed drawings. These aspects are indicative of only a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The embodiments of the present invention disclosed herein are illustrated by way of example, and not by way of limitation, in the figures of the accompanying drawings, in which reference numerals may refer to similar elements.

FIG. 1 provides an exemplary embodiment detailing the composition and creation of a biodegradable insect control medium comprised of a dual-action tablet.

FIG. 2 provides an exemplary embodiment of the biodegradable insect control medium comprised of a dual-action product.

### DETAILED DESCRIPTION OF THE PRESENT INVENTION

The innovation is now described with reference to the drawings, wherein reference numerals are used to refer to elements throughout. In the following description, for purposes of explanation, numerous specific details are set forth to provide a thorough understanding of the present invention. It may be evident that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As used in this disclosure, “insecticidal oils” includes cold-pressed oils and essential oils, whether these oils are natural or synthetic. Insecticidal oils may be ovicidal, larvicidal, adulticidal, all-stage insecticidal, or combinations thereof and/or may be an oil that desirably reduces the oviposition deterrence of some essential oils. Further, “oviposition influencing agents” or “OIAs” may refer to ingredients that are oviposition attracting agents or ingredients that mask oviposition deterrents and influence oviposition factors and rates for insects, mosquitoes, or other pests. Notably, mosquitoes are aquatic or semi-aquatic (depending on the definitional source) insects, which are a type of pest. Finally, unless otherwise noted, all percentages provided in the following disclosure are by weight and all ratios are molar. “About” is used in conjunction with percentages, rations, and weights to indicate small variance (less than 5% of the proposed amount).

Previous inventions in the field of pest, insect, and mosquito control primarily focused on complex mechanisms such as oxidation processes requiring control units, physical traps for adult mosquitoes, encapsulations requiring ingestion of the encapsulating material, or liquid formulations with toxic agents. Many of these methods involve components that are either environmentally unfriendly, costly, or limited in their effectiveness by not specifically targeting the egg or larval stage of mosquitoes or by requiring ingestion of a localized material. Some prior solutions focused on specific essential oils or chemical insecticides, while others employed physical traps or coating-based methods. In contrast, the present invention solves many aspects of using insecticidal oils offering a biodegradable medium that combines the use of insecticidal oils with OIAs, providing a dual-action mechanism that either attracts or, at least, does not deter female mosquitoes from laying eggs in treated water and subsequently killing the eggs and/or larvae. Further, the present invention disrupts the development of eggs and/or larvae through external contact, which is quite easier to ensure versus requiring ingestion by the larvae or adult mosquitoes. The present invention is an environmentally friendly, cost-effective, and easy-to-use solution that addresses the lifecycle of mosquitoes at least at the egg or the larval stage, ensuring a more comprehensive and sustainable approach to mosquito lifecycle control. Notably, while this disclosure is written to focus on insect and mosquito lifecycle control, the present invention may be used to help control the lifecycle and/or populations of a variety of pests.

By using the insecticidal mechanisms of insecticidal oils and enhancing them through encapsulation and synergistic oil combinations, the present invention offers an effective, environmentally friendly, and sustainable solution for controlling the mosquito lifecycle by targeting their eggs and/or larvae. Synergistic blends of insecticidal oils provide a sum of benefits greater than their parts. For example, a first insecticidal oil may be a very effective larvicide but also produce a strong odor which negatively impacts oviposition; therefore, a blend including a second insecticidal oil which does not significantly affect oviposition while not diminishing the efficacy of the first insecticidal oil and thus produces better results than using either insecticidal oil on its own. Synergistic blends of insecticidal oils may be developed to target specific insects (such as mosquitoes) or specific species or variants of a particular insect (such as the Aedes aegypti and Aedes albopictus species of mosquito, known for carrying Zika virus).

This innovative approach provides a sustainable and effective solution for aquatic or semi-aquatic insect control by addressing the critical limitations of using essential oils and cold-pressed oils in their natural forms. Enhanced solubility ensures that these insecticidal oils disperse evenly in water, maximizing ovicidal and larvicidal activity throughout the entire water body rather than concentrating in a limited zone near the point of release. Reduced volatility prevents rapid evaporation, desirably improving long-term effectiveness. Finally, minimizing the oviposition deterrence present in some insecticidal oils may conceal the physical and chemical sensory cues that would otherwise repel mosquitoes, possibly even encouraging the aquatic or semi-aquatic insects to lay eggs in a body of treated water.

As noted above there is an urgent need for innovative solutions that target insects, particularly mosquitoes, at their source-primarily within bodies of water where they breed without the negative impacts associated with traditional methods. The present invention, in some embodiments, uses insecticidal oils encapsulated in a biodegradable matrix, providing an eco-friendly and sustained release of ovicidal and/or larvicidal agents without ecologically harsh chemicals. Also, some embodiments of the present invention may include CO₂-producing compounds or oviposition attraction agents to simulate desirable conditions for reproducing mosquitoes. Further, the present invention may include compounds that reduce the oviposition deterrence cues typically associated with some insecticidal oils. A delivery medium or tablet (or multiple delivery mediums or tablets) made with the biodegradable matrix may be directly placed in water bodies, eliminating the need for additional dispersal equipment. Therefore, the present invention provides a more integrated and effective solution with its biodegradable delivery medium or tablet, OIAs, and insecticidal oil composition than traditional pest, insect, and mosquito control methods.

The present invention, in some embodiments, provides an innovative biodegradable insect control medium that is designed to effectively disrupt the mosquito lifecycle by targeting their lifecycle at the larval stage. This medium may be manufactured and delivered to a body of water in various forms of delivery mediums including segments, portions, tablets, spheres, granules, gels, liquids, emulsifications, water-soluble containers or pouches, and other similar forms suited for packaging, transport, use, and release of the medium's contents into the body of water. In further embodiments, the present invention may also produce ovicidal and/or adulticidal results (effectively being fully insecticidal). However, most embodiments of the present invention seek to destroy pests at their egg or larval stages before they may annoy and/or transmit diseases among humans and/or animals. In alternative embodiments, the biodegradable insect control medium(s) could be a single tablet, a combined (sometimes-called dual-action) tablet, a plurality of tablets (separated, mixed, or bound together), in the form of a powder, a gel, a solution, a brickette, a tab, a pod, a mixture, a spray, or any combination of these forms of a delivery medium for an active ingredient(s) and/or an OIA(s). A “delivery medium” (or just “medium”) should be understood to include any rational form of the active ingredients, OIAs, biodegradable matrix, encapsulating agents, adhesive layers, or other components of the biodegradable insect control medium that could take or be included in to transport the desired compounds to the body of water to achieve the desired result of ovicide, larvicide, adulticide, pesticide, oviposition attraction, oviposition deterrent-masking, etc. as contemplated by the present invention. Most often, the tablet form of the delivery medium may be used in the present disclosure because it has proven to be one of the most effective delivery mediums and for the ease of comprehension by a user (such as an individual who commercially purchased the present invention from a retailer).

In some embodiments, the present invention comprises two types of biodegradable tablets: a first tablet for ovicidal and/or larvicidal purposes and a second tablet comprising at least one OIA. The combined action of these two tablets ensures a comprehensive, environmentally friendly, and sustainable approach to pest or mosquito lifecycle control. Further, the size and shape of a tablet, as well as their compactness and/or density, may greatly affect the release rate of that tablet's contents. In alternative embodiments, the tablets and/or their active ingredients (i.e., the insecticidal oils or other effective ingredients) may be combined into an alternative delivery medium (such as a combined tablet, powder, liquid, or gel).

The first tablet may be formulated to gradually release encapsulated insecticidal oils into a receptacle or body of water (or merely “water”), becoming “treated water.” Insecticidal oils may have ovicidal, larvicidal, oviposition attraction, oviposition deterrence, and/or other properties. Some insecticidal oils may exhibit ovicidal (egg destruction), larvicidal (larvae destruction), or both properties. These insecticidal oils may be selected from a group consisting of anise oil, basil oil, black seed oil, cedarwood oil, celery oil, chamomile oil, cinnamon oil, citronella oil, clove oil, cornmint oil, curry leaf oil, dill oil, fennel oil, garlic oil, geranium oil, ginger oil, lavender oil, lemon oil, lemongrass oil, lime oil, orange oil, peppermint oil, rosemary oil, spearmint oil, thyme oil, yarrow oil, and combinations thereof. Further embodiments may include additional insecticidal oils to the preceding list including: argan oil, avocado oil, bergamot oil, black cumin seed oil, black pepper oil, borage oil, carrot seed oil, castor oil, cedar leaf oil, clary sage oil, coconut oil, coriander oil, eucalyptus oil, evening primrose oil, fir needle oil, frankincense oil, grapefruit oil, jojoba oil, kukui nut oil, lemon eucalyptus oil, macadamia oil, marjoram oil, marula oil, meadowfoam seed oil, neem oil, patchouli oil, pine oil, rosehip oil, rosewood oil, sandalwood oil, sage oil, spearmint oil, sunflower oil, tamanu oil, vetiver oil, wintergreen oil, and combinations thereof including this list and the preceding list.

These insecticidal oils are well-known for their ovicidal and/or larvicidal properties, effectively killing mosquito eggs and larvae upon exposure to the insecticidal oils. A receptacle of water may also be a body of water and should be understood to include any amount of water which is capable of supporting pest propagation.

Further, the first tablet may include carrier oils in addition to the insecticidal oils. Carrier oils are often used in combination with insecticidal oils due to their light consistencies and general odorlessness. These carrier oils may somewhat dilute the insecticidal oils in addition to giving the insecticidal oils increased movement across the surface of and/or within the body of water. Carrier oils include oils such as rosehip seed oil, tamanu seed oil, grapeseed oil, avocado oil, macadamia oil, castor oil, black seed oil, sweet almond oil, olive oil, coconut oil, evening primrose oil, cottonseed oil, linseed oil, sesame oil, and more.

One of the significant challenges with using insecticidal oils is their oviposition deterrent effect on pests (such as female mosquitoes), which limits insecticidal oils use as natural ovicidal/larvicidal agents. Further, insecticidal oils are not water-soluble, which causes them to pool and restricts their ovicidal and larvicidal efficacy to the pooled-oil locations. The present invention addresses these issues in two ways. First, by encapsulating the insecticidal oils using various natural encapsulating agents, including but not limited to α-cyclodextrin, β-cyclodextrin, γ-cyclodextrin, cellulose, cork, guar gum, gum arabic, maltodextrin, pectin, gelatin, sodium alginate, yeast, hydroxypropyl methylcellulose (“HPMC”), silica, chitosan, and carrageenan. This encapsulation method ensures that the insecticidal oils are dispersed as micro-droplets and homogenized in water, desirably making the insecticidal oils less detectable to pests like female mosquitoes on or above the water's surface. Second, by combining synergistic blends of insecticidal oils, creating blends that require less total insecticidal oil, leading to lower oviposition deterrence, but that remains effective ovicides/larvicides. These combine to allow the insecticidal oils to act as effective ovicides/larvicides while minimally deterring pests such as mosquitoes from laying their eggs in the treated water.

The insecticidal oils in the tablet may be encapsulated to ensure a controlled and gradual release of the insecticidal oils into the water. This encapsulation maintains the effectiveness of the insecticidal oils over an extended period. The slow-release mechanism is crucial for providing prolonged availability of the ovicidal/larvicidal agents, thereby increasing the overall effectiveness of the present invention. The encapsulation process plays a crucial role in enhancing the efficacy of the insecticidal oils used as an ovicide/larvicide by addressing the oils'solubility, volatility, and repellency characteristics. Many insecticidal oils are hydrophobic by nature, meaning they do not naturally dissolve in water. To overcome this, the insecticidal oils may be encapsulated using hydrophilic and/or hydrophobic encapsulating agents such as α-cyclodextrin, albumin, alginate, beeswax, β-cyclodextrin, calcium carbonate, carnauba wax, carrageenan, casein, cellulose, chitosan, cholesterol, ethyl cellulose, fatty acids, gelatin, glutaraldehyde crosslinked polymers, γ-cyclodextrin, guar gum, gum arabic, hydroxypropyl methylcellulose, liposomes, maltodextrin, methylcellulose, microcrystalline cellulose, montmorillonite clay, pectin, polyethylene glycol, polyhydroxyalkanoates, polylactic acid, poly(lactic-co-glycolic acid), polyvinyl alcohol, sodium alginate, sodium carboxymethyl cellulose, silica, soy protein, stearic acid, starch, triglycerides, whey protein, xanthan gum, yeast, and combinations thereof. In particular, a combination of at least one hydrophilic and at least one hydrophobic encapsulating agents may be desired as the hydrophilic encapsulating agent encourages dissolution of the contents of the tablet into the body of water while the hydrophobic encapsulating agent provides resistance to quick dissolution creating the desirably slow-release mechanism which ensures efficacy over a period of time.

In some exemplary embodiments, β-cyclodextrin forms inclusion complexes with insecticidal oils, thereby encapsulating them. The hydrophobic cavity of β-cyclodextrin traps the insecticidal oil molecules, while the hydrophilic outer surface interacts with water. This encapsulation allows the otherwise water-insoluble insecticidal oils to become dispersed and effectively homogenized in the aqueous environment. Other encapsulation agents like sodium alginate and HPMC create a hydrophilic matrix around the insecticidal oils. Some encapsulating agents and matrixes may not dissolve in water, but alternatively swell, break apart, or have another physical change caused by the water's effect on the encapsulating agent and/or matrix to facilitate the release of the insecticidal oil(s) and/or OIA(s) into the body of water. When the tablet dissolves in water or otherwise releases the insecticidal oil(s) and/or OIA(s), this matrix may further facilitate the dispersion of the insecticidal oils and OIAs into fine droplets or granules, effectively emulsifying them and maintaining a uniform distribution in the treated water.

Many insecticidal oils contain volatile compounds, meaning they readily evaporate when exposed to air and temperature, which may significantly reduce their effectiveness over time. Encapsulation helps mitigate this issue by forming a protective barrier around the insecticidal oils, reducing their exposure to air and temperature which are primary factors causing evaporation and degradation. This barrier helps in retaining the volatile compounds of the insecticidal oils, ensuring they remain effective for a longer duration. In some embodiments, the encapsulated insecticidal oils are gradually released into the water as the water-soluble and/or biodegradable matrix, coating, shell, etc. of the tablet decomposes or dissolves in what may be referred to as a controlled release mechanism. This controlled release mechanism ensures the sustained presence of the active ingredients within the water, maintaining larvicidal activity over an extended period and preventing the rapid loss of efficacy due to evaporation.

Insecticidal oils may serve as repellents, deterring pests such as female mosquitoes from laying their eggs in the treated water. Encapsulation is one method of addressing this challenge by masking the sensory properties of the insecticidal oils (i.e., their fragrance and/or taste). By encapsulating the insecticidal oils, we minimize the risk of immediate detection of some of the insecticidal oils' characteristic odors and tastes. This masking effect prevents the insecticidal oils from repelling mosquitoes when approaching the water's surface or tasting the water. As the encapsulated insecticidal oils are slowly released into the water, their concentration remains below the threshold that would trigger the mosquitoes' repellent response. This gradual release ensures that the insecticidal oils are present in effective concentrations for killing larvae without deterring egg-laying behavior in the adult mosquitoes. Additionally, the present invention may include porous ingredients within the tablet(s) such as hay, cellulose, and sawdust to absorb or adsorb free (un-encapsulated) oils. This adsorption may reduce the concentration of free oils in the water, preventing the free oils from increasing the total oil concentration to a level that would trigger oviposition deterrence and repellency in pests, such as mosquitoes. This secondary adsorption may occur dynamically as needed and provides a desirable absorption mechanism for capturing excessive free oils.

Certain pests, like gravid female mosquitoes, are highly selective when choosing an oviposition site. Site selection uses physical cues, such as visual contrast or surface texture, and chemical cues, such as allomones, kairomones, and pheromones. One of the main challenges in using insecticidal oils is that some generate strong smell and taste cues in mosquitoes, even at moderate total insecticidal oil concentrations. To overcome this issue, the present invention uses synergistic blends of insecticidal oils that were tested and found to be highly effective as larvicides/ovicides while minimizing the insecticidal oil's negative effects on factors such as oviposition, dispersion within the body of water, etc. This blending allows lower total amounts of insecticidal oils, thus greatly reducing the adverse effect of the insecticidal oil's physical stimuli on mosquito oviposition. Additionally, the present invention may use ingredients such as hay, cellulose, and sawdust that, through microbial fermentation, released a scent that further masks some insecticidal oil's oviposition deterring gustatory and olfactory cues.

The encapsulation of insecticidal oils in the ovicidal/larvicidal tablet significantly enhances their functional properties, ensuring that the insecticidal oils are water-soluble, less volatile, and less repellent to mosquitoes. This innovative approach provides a sustainable and effective solution for insect control by addressing the critical limitations of using insecticidal oils in their natural or base processed (if synthetic) form. Techniques may be employed to create enhanced solubility for the tablets ensuring that the insecticidal oils are evenly distributed in the water, maximizing larvicidal action. Further encapsulation techniques may be used to produce tablets with reduced volatility to prevent rapid evaporation, maintaining long-term effectiveness for the insecticidal oils. Finally, ideal tablets provide minimized repellency to conceal the oviposition deterring cues of insecticidal oils that would otherwise repel the mosquitoes, encouraging them to lay eggs in the treated water.

Encapsulating agents used in the biodegradable insect control tablets play a critical role in ensuring the controlled release of the active ingredients, specifically insecticidal oils, over an extended period. This controlled release mechanism is essential for maintaining the effectiveness of the insecticidal oils and preventing their rapid degradation and evaporation. The encapsulating agents that may be used include α-cyclodextrin, β-cyclodextrin, γ-cyclodextrin, cellulose, cork, guar gum, gum arabic, xanthan gum, maltodextrin, pectin, gelatin, sodium alginate, yeast, HPMC, silica, chitosan, carrageenan, and combinations thereof. Each of these agents has unique chemical and physical properties that contribute to the controlled release process. Some examples of encapsulating agents and their functions include:

Cyclodextrins are cyclic oligosaccharides composed of several glucose units linked by α-1,4-glycosidic bonds, forming a truncated cone shape. The interior of the cavity is relatively hydrophobic, while the exterior is hydrophilic. Cyclodextrins form inclusion complexes with hydrophobic guest molecules, such as insecticidal oils constituents, by trapping them within its hydrophobic cavity. When placed in water, the hydrophilic outer surface interacts with the aqueous environment, allowing the complex to gradually dissolve. As the β-cyclodextrin dissolves, it slowly releases the encapsulated insecticidal oils into the water. This gradual release is controlled by the dissolution rate of the β-cyclodextrin, which ensures a sustained presence of the insecticidal oils and/or agents in the water Further, insecticidal oils remain in the water at effective yet less repellent concentrations for an extended period because release is dissolution-controlled.

Cellulose is a natural polymer composed of β-1,4-linked glucose units. It is hydrophilic and forms a fibrous structure, providing structural integrity and biodegradability. When used as an encapsulating agent, cellulose forms a matrix around the insecticidal oils. In an aqueous environment, cellulose absorbs water and swells, leading to a slow release of the encapsulated essential oils as the insecticidal oils diffuse through the hydrated matrix. This swelling and degradation process ensures that the insecticidal oils are released over an extended period, maintaining effective concentrations in the water. Cellulose may be made from a variety of raw materials, each of those raw materials may provide slightly different benefits. Common cellulose raw materials include wood and other plants including coconut husks, sugarcane bagasse, corn cobs, bamboo, wheat straw, cotton, etc.

Sodium alginate is a natural polysaccharide extracted from brown seaweed. Sodium alginate consists of α-L-guluronic acid and β-D-mannuronic acid units. In the presence of calcium ions, sodium alginate forms a gel through ionic cross-linking. Sodium alginate is used to form a gel-like encapsulation around the insecticidal oils. When the tablet is placed in water, the alginate gel remains intact and instead releases the insecticidal oils by diffusion and ion-exchange-driven erosion, providing controlled release. The gel matrix protects the insecticidal oils from rapid degradation and volatilization, ensuring their gradual release and prolonged effectiveness.

Guar gum and gum arabic are natural polysaccharides that form viscous solutions in water. Guar gum is composed of galactomannan, while gum arabic is a complex mixture of glycoproteins and polysaccharides. These gums form a protective coating around the insecticidal oils and/or creating a viscous layer. In water, the hydrated viscous layer allows gradual diffusion of the encapsulated insecticidal oils. This controlled hydration and dissolution process ensures that the insecticidal oils and/or are steadily released over time, maintaining effective larvicidal concentrations within the treated water.

HPMC is a semi-synthetic polymer derived from cellulose. It is hydrophilic and forms a gel-like structure in water. HPMC forms a matrix that encapsulates the insecticidal oils. When the tablet is placed in water, HPMC swells and gradually dissolves, releasing the encapsulated insecticidal oils in a controlled manner. The gel-like structure of HPMC ensures a slow and sustained release, protecting the insecticidal oils from rapid degradation and volatilization.

Yeast cells have a robust cell wall composed of glucans, mannans, and proteins. They may also encapsulate hydrophobic molecules within their cellular structure. They may also encapsulate hydrophobic molecules within internal lipid bodies and pores in the cell wall. In water, the yeast cells degrade slowly and thus slowly release encapsulated insecticidal oils into the water. In some embodiments of the present invention, depending on the production of the tablet, the yeast cells may not be ideal because (again, depending on the process to produce the tablets) the yeast cells may retain the majority of the insecticidal oils, meaning that the larvicidal effect is localized to the area of the treated water where the yeast cells collect. Therefore, in these embodiments, the tablets may act as a weak ovicide under stagnant conditions (low water motility). Further, the efficacy of such embodiments is largely dependent on yeast consumption by the pests, having a lower impact on lifecycle control.

All encapsulating agents are designed to interact with water in a way that facilitates the gradual release of the encapsulated insecticidal oils. When the tablets are placed in an aquatic environment, each encapsulating material engages with the aqueous phase in its characteristic way, such as by dissolving, hydrating, diffusing, or slowly eroding. These water-driven interactions release the encapsulated insecticidal oils into the water over time, achieving a controlled, prolonged release. This controlled release mechanism ensures that the insecticidal oils maintain effective concentrations over an extended period, enhancing their ovicidal and larvicidal effectiveness while minimizing the risk of rapid evaporation, degradation, and mosquito oviposition deterrence. Moreover, the biodegradable nature of desirable encapsulating agents ensures that the tablets break down into non-toxic by-products, making the biodegradable insect control tablets environmentally friendly and safe. The gradual release of insecticidal oils and the environmentally benign nature of the encapsulating agents contribute to a sustainable and effective biodegradable insect control tablet.

In some embodiments, the tablets are composed of insecticidal oils encapsulated either in an encapsulating agent or directly in a biodegradable matrix, which may be primarily made of a material such as cellulose. The biodegradable matrix may also be comprised of other suitable materials such as cellulose derivatives, β-cyclodextrin, starch, pectin, alginate, chitosan, gelatin, carrageenan, guar gum, xanthan gum, pullulan, soy protein isolate, whey protein, and combinations thereof. This biodegradable matrix allows the tablet or other delivery medium to naturally decompose in the water environment minimizing undesired ecological harm because of the rate of release of the active ingredients. This rate of release is determined by the material(s) used for the biodegradable matrix, the encapsulation method used to create the tablet, the ratio of the encapsulating agent to insecticidal oil, and the composition of the body of water. Factors such as pH, pollutants, contaminants, salination, etc. may have an effect on the biodegradable matrix's rate of decomposition and therefore the rate of release of the active ingredient(s). The biodegradable nature of the biodegradable matrix also supports the gradual release of the encapsulated insecticidal oils. Upon dissolution in water, the first tablet gradually releases the encapsulated insecticidal oils. These insecticidal oils may disrupt pests'lifecycles such as the cellular processes of mosquito eggs and larvae, effectively killing the eggs and/or larvae and preventing them from maturing into adult mosquitoes. In some embodiments, the tablets are designed to be effective for a desired period of time, such as up to 30 days, maintaining an effective concentration of insecticidal oils in the water to continuously kill mosquito larvae during that period. In alternative embodiments, the tablets may be designed to last above a set concentration threshold for a number of hours, days, or months. Biodegradable matrixes such as cellulose may be an ideal delivery method for the encapsulated insecticidal oils to reach insect larvae that ingest the cellulose in addition to providing a prolonged release of the encapsulated insecticidal oils into the body of water. In some embodiments, the biodegradable matrix may be an OIA.

The second tablet may be designed to release oviposition influencing agents (or OIAs) into the treated water. These OIAs might attract oviposition or help active ingredients from deterring oviposition and/or the OIAs may mask the oviposition deterring effect of some insecticidal oils. The OIA may be selected from the group including natural or manufactured ingredients like corn cobs, coffee grounds, bran, bread crumbs, agar, almond hulls, almond shells, animal glue, bone meal, cat food, casein, canary seeds, cellulose, cheese, citrus pulp, cocoa shell flour, cocoa shells, cookies, cork, cotton, cracked wheat, dried blood, egg shells, eggs, fish meal, fish oil, fructose, gelatins, glycerin, guar gum, gum arabic, gum tragacanth, hay, hydrolyzed proteins, hydrolyzed vegetable proteins, malt extract, malt flavor, maltodextrin, milk, millet seed, molasses, lactose, peanut shells, peanuts, peat moss, pectin, soybean meal, sawdust, soybean flour, sodium bicarbonate, syrups, saccharose, wheat, wheat flour, whey, xanthan gum, yeast, lactic acid, acetic acid, propionic acid, butyric acid, valeric acid, hexanoic acid, octanoic acid, nonanoic acid, decanoic acid, undecanoic acid, dodecanoic acid, tetradecanoic acid, pentadecanoic acid, palmitic acid, heptadecanoic acid, stearic acid, oleic acid, linoleic acid, linolenic acid, arachidic acid, behenic acid, lignoceric acid, cerotic acid, montanic acid, melissic acid, phenol, p-cresol, indole, skatole, 4-methylcyclohexanol, octenol, geraniol, citronellol, eugenol, thymol, camphor, furfural, vanillin, benzaldehyde, hexanal, nonanal, decanal, benzyl alcohol, methyl jasmonate, methyl salicylate, limonene, alpha-pinene, beta-pinene, myrcene, caryophyllene, farnesol, nerolidol, linalool, benzothiazole, 2-undecanone, 2-tridecanone, 2-undecanol, geosmin, indole-3-acetic acid, skatole derivatives, and combinations thereof.

Further, certain emulsifiers and surfactants may also be used to aid in the delivery and disbursement of the insecticidal oil(s) within the treated water, including: Tween 20, Tween 40, Tween 60, Tween 80, Span 20, Span 40, Span 60, Span 80, lecithin, sodium dodecyl sulfate, sodium lauryl sulfate, sodium laureth sulfate, hydrogenated castor oil, PEG-40 hydrogenated castor oil, PEG-7 glyceryl cocoate, PEG-100 stearate, PEG-8 laurate, polyethylene glycol, polyethylene glycol oleate, polyglyceryl esters, sucrose esters, glyceryl stearate, glyceryl oleate, glyceryl laurate, sodium stearoyl lactylate, cetyl alcohol, stearyl alcohol, cetearyl alcohol, lauryl glucoside, decyl glucoside, coco glucoside, caprylyl glucoside, capryl glucoside, poloxamers, Brij surfactants, sorbitan monolaurate, sorbitan monooleate, sorbitan tristearate, sorbitan stearate, sodium oleate, sodium cocoyl isethionate, disodium laureth sulfosuccinate, cocamidopropyl betaine, lauramidopropyl betaine, cocoamidopropyl hydroxysultaine, polyquaterniums, benzalkonium chloride, cetyltrimethylammonium bromide, sodium lauroyl sarcosinate, sodium cocoyl glutamate, sodium methyl cocoyl taurate, ammonium lauryl sulfate, ammonium laureth sulfate, alkyl polyglucosides, fatty alcohol ethoxylates, laureth-4, laureth-7, myreth-3, myreth-7, PEG-6 caprylic glycerides, PEG-6 capric glycerides, PEG-40 castor oil, PEG-60 hydrogenated castor oil, PEG-20 sorbitan laurate, PEG-20 sorbitan oleate, PEG-20 sorbitan stearate, PEG-12 dimethicone, ceteareth-20, ceteareth-12, polysorbates, isostearyl isostearate, sodium lauroyl lactylate, stearic acid, oleic acid, lauric acid, myristic acid, caprylic triglycerides, capric triglycerides, and combinations thereof.

OIAs may mimic conditions, smells, or other factors occurring at natural mosquito breeding sites, creating an environment that lures female mosquitoes to lay their eggs in the treated water and/or increases the likelihood that female mosquitoes lay their eggs in the treated water. These agents may decompose in the treated water, releasing volatile organic compounds (VOCs) and small amounts of CO₂ that together mimic the chemical profile of natural mosquito breeding sites. The decomposition of these organic materials is facilitated by microbial activity, which may be naturally present in the OIAs and/or the aquatic environment. As the microbes metabolize organic attractants, they produce CO₂ and other by-products that mimic the olfactory cues of natural mosquito breeding sites. The release of these fermentation-derived VOCs may create an environment that simulates the conditions found in stagnant water bodies where mosquitoes typically lay their eggs. These chemical cues are highly attractive to pests, such as gravid mosquitoes, which are drawn to the treated water for oviposition. The gradual release of these oviposition attractants ensures that the water remains appealing to mosquitoes for an extended period, increasing the likelihood of egg-laying in the treated area. In some situations, the body of water may already present a desirable egg-laying location for pests, in which case the OIAs may not need to attract pests but rather only need to mask the oviposition deterring effects of some insecticidal oils. The strategic use of biodegradable and natural materials not only enhances the effectiveness of the biodegradable insect control medium but also ensures environmental safety and sustainability. The gradual decomposition process maintains a steady release of OIAs, providing long-term effectiveness in luring mosquitoes to lay their eggs in the treated water, where the emerging larvae will subsequently be exposed to the larvicidal effects of the tablet(s).

OIAs may be designed to mask the insecticidal oil's oviposition deterring chemical and physical cues and/or effects. These OIAs primarily consist of biodegradable materials that, upon introduction into an aqueous environment, undergo gradual decomposition and mild fermentation. During this process, the lignocellulosic and/or polysaccharide matrices of these OIAs absorb water and facilitate microbial activity, resulting in the slow release of VOCs characteristic of decomposing plant matter. The fibrous particles of these OIAs absorb and sequester a portion of the volatile fractions of the insecticidal oils present in the composition, effectively reducing the intensity of olfactory and gustatory stimuli emanating from the insecticidal oils. Through this combined mechanism of slow biodegradation and volatile compound absorption, the oviposition deterrent masking OIAs effectively reduce the perceptibility of the insecticidal oils to target and non-target organisms (i.e., pests, mosquitoes, etc.).

In some embodiments, the tablet(s) may also contain a biodegradable matrix made of cellulose, which provides a substrate that can support the gradual release of CO₂ and VOCs. The biodegradable material used in the first tablet (or “a first biodegradable matrix”) may be the same or a different biodegradable material than that used in the second tablet (or “a second biodegradable matrix”). In some embodiments, the tablet sustains the release of CO₂ and other oviposition attractants over a desired period of time (for example; up to 30 days), ensuring that female mosquitoes are consistently attracted to the treated water. This sustained oviposition attraction is essential, in some embodiments, for maximizing the effectiveness of the biodegradable insect control tablet. In alternative embodiments, the tablet may be designed to more quickly dissolve or otherwise release the tablets contents within the body of water so that the environmental microbes can readily metabolize the encapsulation and/or biodegradable matrix of the tablet as it dissolves within the body of water over its desired period of release.

The present invention is considered a two-part process of (1) (a) oviposition attraction and/or (b) oviposition deterrent masking for insecticidal oils (or “combined oviposition action”), and (2) the destruction of eggs and/or larvae by the insecticidal oil. The medium may create an environment that lures female mosquitoes to lay their eggs or mask factors that might deter female mosquitoes from laying their eggs and ensures that those eggs and/or emerging larvae are exposed to lethal concentrations of insecticidal oils. This combination provides a comprehensive approach to mosquito lifecycle control, effectively disrupting the mosquito lifecycle and, most notably, helping curb the spread of mosquito-borne diseases in animals and humans.

In some embodiments, the tablets may be designed to float on the water surface, allowing the tablet to release its active ingredients primarily at the surface. This could be beneficial to target surface-oriented organisms or pests that spend time at the air-water boundary, such as midge pupae or adult insects.

In some embodiments, the tablet may be packaged in a moisture-resistant container to ensure stability before use. This packaging protects the tablet from premature degradation and maintains its efficacy. The moisture-resistant container is designed to keep the tablets dry and stable until they are ready to be deployed in the water.

Several embodiments of the present invention may be considered to enhance the versatility and effectiveness of the biodegradable insect control tablet. For instance, the tablet may contain combinations of various insecticidal oils to target specific pests and even specific species such as a certain species of mosquitoes. These insecticidal oil mixtures may be formulated for specified mosquito populations or geographic regions. In an alternative embodiment, the tablet may include varying the concentration of insecticidal oils to adjust the release rate and duration of effectiveness. For example, a higher concentration of insecticidal oils may be used for areas with high mosquito infestation, providing a more potent and long-lasting ovicidal and/or larvicidal effect. The tablet may also be formulated with different combinations of OIAs to mimic specific environmental conditions that attract desired mosquito species. This formulation may include using OIAs that produce specific chemical cues known to target particular mosquito species, enhancing the effectiveness of the tablet. This formulation may also include using OIAs selected to mask specific insecticidal oil's chemical or physical cues. Additionally, the tablet may be designed with different buoyancy characteristics to ensure it remains afloat or sinks in various water conditions, such as ponds, lakes, and marshes. This variability ensures that specific formulations and/or physical characteristics acquired through production of the tablets may be used effectively in diverse aquatic environments. The biodegradable insect control tablet may also be adapted for use in pest or mosquito management programs, where the tablet is deployed in combination with other biodegradable insect control methods and mediums, such as physical barriers and biological control agents. This integrated approach may provide a more comprehensive and sustainable solution to mosquito lifecycle control.

In one embodiment of the invention, the ingredients of the composition may be apportioned into two or more distinct tablets. Such configurations may be implemented for a variety of purposes. For example, the separation of tablet functions may be employed, wherein one tablet comprises primarily OIAs, and another tablet comprises ovicidal and/or larvicidal agents (i.e., the insecticidal oils). In another example, a combination of tablets may be provided such that one tablet is formulated for rapid or burst release of active agents, while another tablet is formulated for sustained or slow release, thereby achieving both immediate and prolonged efficacy. Further, in certain embodiments, the separation of ingredients into distinct tablets may be utilized to enhance the shelf-life of the product by physically isolating components that may be chemically or physically incompatible when stored in combination.

In another embodiment of the invention, two or more distinct tablets may be physically connected by an adhesive layer, forming a single unit that can be easily deployed in water. This embodiment may be considered a single tablet that is compartmentalized, segregated, or fashioned in such a way that the OIAs and insecticidal oils do not interact or mix prior to their release into the water. The adhesive layer may be designed to be water-soluble, ensuring that it dissolves instantly or gradually, as desired once the tablet(s) are placed in the water. The adhesive layer not only keeps the tablets together during storage and transportation but may also ensure that the tablets (or portions, sections, etc. of the tablet) stay in close proximity when deployed, maximizing the synergistic effect of the multiple mechanisms (oviposition attraction, oviposition deterrent masking, ovicide, larvicide, etc.). As the adhesive layer dissolves, both segments of the tablets may float or sink freely, releasing their respective active ingredients simultaneously (either at the same or different rates). This embodiment simplifies the deployment process by allowing users to handle and place a single tablet rather than two or more separate tablets, making these embodiments particularly advantageous for large-scale applications and in diverse aquatic environments. The adhesive layer may be made of water-soluble materials that are ecologically friendly such as agarose, alginates, carboxymethyl cellulose, casein, cellulose, chitosan, dextrin, dextran, gellan gum, guar gum, hydroxyethyl cellulose, HPMC, hydroxypropyl starch, inulin, locust bean gum, maltodextrin, methylcellulose, microcrystalline cellulose, polyvinyl alcohol, pullulan, pectin, sodium alginate, sodium caseinate, sodium starch glycolate, soy protein isolate, starch, tamarind seed polysaccharide, tara gum, whey protein, wood pulp, xanthan gum, other suited materials which are able to dissolve in water with no or minimal agitation, and combinations thereof.

In another embodiment, the ovicidal and/or larvicidal tablet containing the encapsulated insecticidal oils can be used as a standalone biodegradable insect control tablet. This tablet may be designed to be effective on its own by releasing the insecticidal oils gradually into the water, killing mosquito eggs and larvae without the need for additional oviposition influencing agents. This embodiment is particularly useful in scenarios where mosquito breeding sites are already known and do not require OIAs to lure mosquitoes. This tablet may be deployed into water bodies (such as ponds, bird baths, and rain barrels) where the tablet will release the insecticidal oils over a period (such as up to 30 days). This embodiment provides an effective and environmentally friendly solution for controlling mosquito lifecycles in localized areas, making it a versatile option for targeted mosquito management.

In some embodiments, the biodegradable insect control medium offers an innovative, sustainable, and effective method for disrupting the mosquito lifecycle by targeting the egg or larval stage. The combination of ovicidal, larvicidal, and OIA tablets ensures a comprehensive approach to mosquito lifecycle control, addressing the need for environmentally friendly and sustainable strategies to combat mosquito-borne diseases. The detailed design and various embodiments of the invention provide versatility and adaptability, making it suitable for use in a wide range of aquatic habitats and regions.

The biodegradable insect control medium may be composed of a unique blend of biodegradable materials including at least two of: OIAs, insecticidal oils, and carrier oils, encapsulated within a cellulose matrix that facilitates the controlled release of these substances into an aquatic environment. In some embodiments, the primary component of the biodegradable matrix is cellulose, a natural polymer known for its biodegradability and non-toxic nature. Cellulose serves as the scaffold within which the insecticidal oils, carrier oils, and OIAs may be embedded, allowing for gradual degradation and release of the active ingredients into the water over time. The biodegradable matrix may constitute about 45% to about 75% of the total tablet weight. Additionally, CO₂ and VOCs releasing compounds such as ground corn cobs, flour, hay, yeast, sawdust and coffee grounds may be incorporated, which naturally ferment to release CO₂ and VOCs when exposed to water. VOCs act as a major oviposition influencing cue to mosquitoes, with CO₂ acting as an additional, lesser cue. These compounds may alternatively be used to absorb and sequester a portion of the volatile fractions of the insecticidal oils (thus service as oviposition deterring maskers). Collectively, the plurality of OIAs may make up approximately 10% to about 40% of the tablet's composition.

To stabilize the volatile insecticidal oils and enhance their longevity and release profile, α-cyclodextrin, β-cyclodextrin, γ-cyclodextrin, may be used as an encapsulating agent. Alginate, another biopolymer, may be employed to further encapsulate the active ingredients, aiding in the controlled release of the active ingredients and protecting the active ingredients from rapid degradation in aquatic environments. Stabilizers and enhancers may account for about 5% to about 30% of the total tablet composition.

Some embodiments of the present invention may present a biodegradable insect control tablet comprising a first tablet and a second tablet. The first tablet is for ovicidal and/or larvicidal purposes and features a biodegradable matrix, an encapsulation material, and encapsulated insecticidal oils. Further the breaking down (for example, dissolution) of the first tablet may promote thorough dispersion of the insecticidal oils in water (which minimizes the oils'detectability to female mosquitoes). The second tablet for oviposition attraction and/or insecticidal oil masking may feature its own biodegradable matrix and oviposition influencing agents. The first tablet may be designed to release encapsulated insecticidal oils gradually into the water to kill mosquito eggs and/or larvae, while the second tablet may be designed to release VOCs and other oviposition attractants to lure female mosquitoes to lay their eggs in the treated water or to release oviposition deterrent masking agents that reduce the oviposition deterrent effect of insecticidal oils. These combined tablets may be used to increase the likelihood that female mosquitoes lay their eggs in the treated water, providing an environmentally friendly, effective, and sustainable method for the mosquito lifecycle control. The biodegradable insect control medium may include one or more encapsulation agents selected from α-cyclodextrin, β-cyclodextrin, chitosan, hydroxypropyl-β-cyclodextrin, γ-cyclodextrin, gelatin, guar gum, gum arabic, hydroxypropyl methyl cellulose, maltodextrin, methyl-B-cyclodextrin, pectin, silica, xanthan gum, and combinations thereof. The insecticidal oils can be selected from anise oil, basil oil, black seed oil, cedarwood oil, celery oil, chamomile oil, cinnamon oil, citronella oil, clove oil, cornmint oil, curry leaf oil, dill oil, fennel oil, garlic oil, geranium oil, ginger oil, lavender oil, lemon oil, lemongrass oil, lime oil, orange oil, peppermint oil, rosemary oil, spearmint oil, thyme oil, yarrow oil, and combinations thereof. The oviposition influencing agent is selected from the group consisting of corn cobs, coffee grounds, bran, bread crumbs, agar, almond hulls, almond shells, animal glue, bone meal, cat food, casein, canary seeds, cellulose, cheese, citrus pulp, cocoa shell flour, cocoa shells, cookies, cork, cotton, cracked wheat, dried blood, egg shells, eggs, fish meal, fish oil, fructose, gelatins, glycerin, guar gum, gum arabic, gum tragacanth, hay, hydrolyzed proteins, hydrolyzed vegetable proteins, malt extract, malt flavor, maltodextrin, milk, millet seed, molasses, lactose, peanut shells, peanuts, peat moss, pectin, soybean meal, sawdust, soybean flour, sodium bicarbonate, syrups, saccharose, wheat, wheat flour, whey, xanthan gum, yeast, and combinations thereof. The biodegradable matrix may be composed of cellulose and/or derivatives. The encapsulation agent can be a cyclodextrin, more specifically, β-cyclodextrin, with a molar ratio to insecticidal oil ranging from about 1:0.1 up to about 1:100, and more specifically, in some embodiments, 1:9.09. The cold-pressed oil being used as the insecticidal oil may be at least one or a combination of clove oil, garlic oil, lemongrass oil, cedarwood oil, and more specifically a combination of clove oil and garlic oil. The essential oil being used as the insecticidal oil may have a concentration ranging from about 1% to about 60%, and more specifically ranging from about 1% to about 5% of total tablet weight. The cold-pressed oil(s) and the essential oil(s) used in these embodiments combine to form the insecticidal oils. The OLIA may be a combination of cellulose and hay, with concentrations ranging from about 10% to about 40%, more specifically, cellulose in the range of about 5% to about 15% of the total table and hay in the range of about 10% to about 30% of the total tablet.

The encapsulation method may produce inclusion complexes by employing one or more methods including kneading, freeze-drying, spray-drying, high-pressure homogenization, mixing, and co-precipitation. In one exemplary method, the tablet materials may be mixed using one or more methods including tumbling blenders, paddle-blenders, v-blenders, ribbon blenders, ball-mill grinders, extruders, high-speed mixers, agitator mixers, fluidized bed mixers, and conical mixers. The tablet may be produced by at least one type of tableting machine including machinery such as a rotary tablet press, a pneumatic press, a hydraulic press, a hand press, a single punch tablet press, a multi-station tablet press, or an automated tablet press.

The tablets will ideally decompose naturally in the water environment while providing minimal risk to humans. The biodegradable insect control medium may be effective in various-sized stagnant water bodies. The release rate of the insecticidal oils from the tablet may be controlled to maintain an effective concentration in the water for a prolonged period. The active ingredient or insecticidal oil release rate may be desirably between 0.01 μg/mL and 150 μg/mL daily as measured by an release rate analytic method such as UV-Visible Spectroscopy (UV-VIS), Gas Chromatography-Mass Spectrometry (GC-MS), High-Performance Liquid Chromatography (HPLC), Liquid Chromatography-Mass Spectrometry (LC-MS), etc. The analytical method selected for measuring the release rate may depend on several factors such as what type of active ingredient or insecticidal oil is being measured. For example, for an insecticidal oil like clove oil UV-VIS is ideal as clove oil's main active compound, eugenol, is easily measured through UV-VIS. Additionally, some active ingredient or insecticidal oil release rates may vary as different active ingredients or insecticidal oils have different effects on pests, such as mosquitoes. For example, an embodiment of the invention using a strong insecticidal oil, such as clove oil, might have a lower release rate, such as 0.1 μg/mL and 20 μg/mL daily. Further, the tablet(s) may be formulated to release higher concentrations of active ingredients or insecticidal oils shortly after deployment, and lesser concentrations of active ingredient or insecticidal oil later in deployment. This strategy ensures that enough insecticidal oil or active ingredients are present in the treated water at effective concentrations for killing larvae without deterring egg-laying behaviors of the target pest, such as mosquitoes. The tablet may be formulated to produce CO₂, release VOCs, and/or release OIAs gradually through natural decomposition processes. The tablet may be packaged in a moisture-resistant container to ensure stability before use.

Some embodiments of the present invention may include inert ingredients used as or in addition to the biodegradable matrix or other components of the biodegradable insect control medium. These inert ingredients may absorb excess insecticidal oils so that the concentration of insecticidal oils does not become too great within the body of water, whereas an undesirably high concentration of insecticidal oils may send olfactorily or other signals to aquatic or semi-aquatic insects which may deter those insects from laying eggs within the treated body of water. Further, these inert ingredients which have absorbed some amount of insecticidal oils may be consumed by certain species of insects or other pests allowing the desired insecticidal effects to propagate through said insects or pests.

In some embodiments, a method for controlling mosquito lifecycles involve deploying biodegradable insect control tablets in an aquatic environment, where the process includes introducing a first tablet for ovicidal/larvicidal purposes, which contains a biodegradable matrix, an encapsulation material, and encapsulated insecticidal oils, promoting thorough dispersion of the insecticidal oils in water and minimizing their detectability to female mosquitoes; and a second tablet being introduced into the same body of water and containing a biodegradable matrix and CO₂-producing and/or VOC-releasing oviposition attractions and/or attracting oils, and oviposition deterrent masking agents. The first tablet may be constructed to gradually release the encapsulated insecticidal oils into the water to kill mosquito eggs and larvae, while the second tablet releases VOC-releasing and/or other OIAs to increase the likelihood that female mosquitoes lay their eggs in the treated water. The tablets may be maintained in the water for a period sufficient to disrupt the mosquito lifecycle, providing an environmentally friendly, effective, and sustainable method for pest, insect, and/or mosquito control.

In some embodiments, the manufacturing process may involve a direct compression method of all ingredients into tablet or similar form.

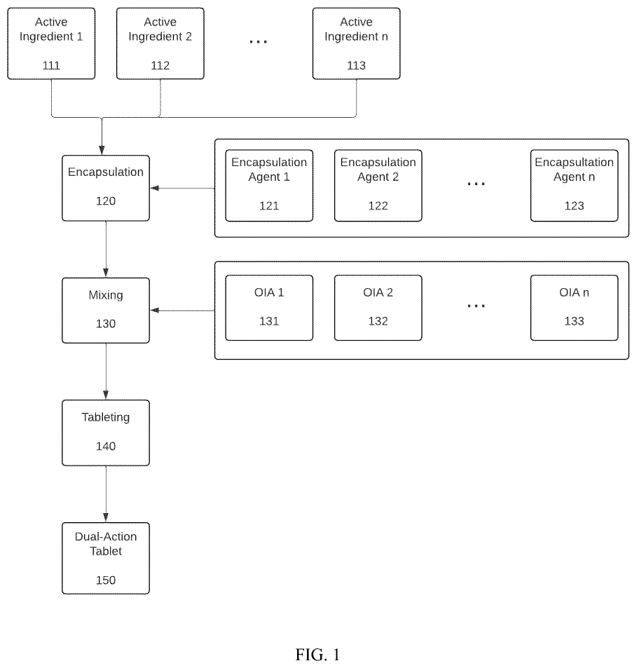

FIG. 1 provides an exemplary embodiment detailing the composition and creation of a biodegradable insect control medium comprised of a dual-action tablet. In some embodiments, a biodegradable insect control medium comprised of a dual-action tablet 100 includes at least one active ingredient 111 (and possibly a second active ingredient 112 and up to n active ingredients 113) which is/are encapsulated using at least one encapsulation method 120 comprising at least one encapsulation agent 121 (and possibly further including a second encapsulation agent 122 and up to n encapsulation agents 123), mixing 130 the encapsulated active ingredient(s) with at least one oviposition-influencing agent (or “OIA”) 131 (and possibly including a second OIA 132 and up to n OIAs 133), and tableting 140 the encapsulated active ingredient(s) and attraction agent(s) to create a singular, dual-action tablet 150. The at least one active ingredient 111 (and subsequent active ingredients 122, 123, etc.) may be comprised of one or more essential oils, one or more of which must exhibit ovicidal properties. The essential oil may also exhibit larvicidal properties. In alternate embodiments, the essential oil may only exhibit larvicidal properties, in which case the ovicidal tablet should be considered a larvicidal tablet.

The encapsulation method 120 should employ at least one encapsulation agent 121 (including components such as a biodegradable matrix or a non-biodegradable matrix) which envelops and/or binds with the active ingredient 121 to form a sustained-released tablet. The encapsulated active ingredient(s) may be mixed 130 with one or more oviposition-attraction (or “attractants”) for attracting ovipositing pests (such as mosquitoes) or one or more oviposition-deterrent-masking agent to decrease the oviposition deterrence of pests (such as mosquitoes) so that the active ingredients are given the opportunity to destroy the pests, their eggs, their larvae, etc. For convenience, the active ingredients and oviposition-influencing agents may be tableted for storage, transport, measuring, and other reasons compounds are tableted for later use. The nature of the dual-action tablet 150 is such that it provides ease of said storage, transport, measurement, etc.

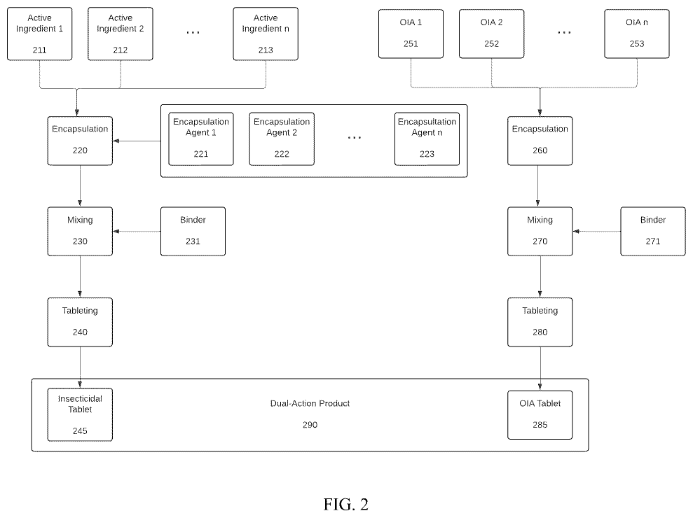

FIG. 2 provides an exemplary embodiment of the biodegradable insect control medium comprised of an ovicidal/larvicidal tablet and an oviposition-influencing agents tablet. In some embodiments, the biodegradable insect control medium comprised of a dual-action product 200 includes an ovicidal/larvicidal tablet 245 comprised of at least one active ingredient 211 (and possibly a second active ingredient 212 and up to n active ingredients 213) which is/are encapsulated using at least one encapsulation method 220 comprising at least one encapsulation agent 221 (and possibly further including a second encapsulation agent 222 and up to n encapsulation agents 223), mixing 230 the encapsulated active ingredient(s) with at least one binder 231, and tableting 240 the encapsulated active ingredient(s) and binder(s) to create the ovicidal/larvicidal tablet 245; and, an OIA tablet 285 comprised of at least one oviposition-influencing agent (or “OIA”) 251 (and possibly a second OIA 252 and up to n OIAs 253) which is/are encapsulated using at least one encapsulation method 260, mixing 270 the encapsulated oviposition-influencing agent(s) with at least one binder 271, and tableting 280 the encapsulated active ingredient(s) and binder(s) to create the oviposition-influencing agents tablet 285. The ovicidal/larvicidal tablet 245 and oviposition-influencing tablet 285 form a dual-action product that attracts and destroys pest eggs.

Pests may be used as an encompassing term and should be understood to include arthropods, particularly those in the Diptera order such as mosquitoes. Most specifically, it should include all of the at least 3,600 species of mosquito.

In some embodiments, cedarwood oil may be used as the active ingredient or essential oil, encapsulated by β-cyclodextrin. Further, a combination of hay and cellulose may be used as oviposition-influencing agents in about a 2:1 ratio.

In some embodiments, the present invention may be deployed in any water-holding receptacle (e.g., bucket, rain-barrel, trap, etc.) or include an ovitrap specifically designed to work with the OLAs and/or active ingredient(s) (such as the insecticidal oils) to attract and/or destroy pest (namely mosquito) eggs and/or larvae. These ovitraps may include varieties such as sticky ovitraps and lethal ovitraps. These ovitraps may contain water and may provide preferred oviposition features such as low light which benefits the eggs. To be practical, any ovitrap used should not require frequent maintenance. This characteristic pairs well with the time prolonged release provided by the biodegradable matrix bound with and/or encapsulating the insecticidal oil(s) and/or OIA(s).

In some embodiments, at least one of the delivery medium may include an exterior coating which delays the dissolution of the delivery medium into the body of water.

In certain embodiments all active and inert ingredients are selected from the lists in 40 C.F.R. § 152.25 (f)(1), § 152.25 (f)(2), or the ingredient is identified as a commonly consumed food commodity, animal feed item, or edible fat or oil as specified in 40 C.F.R. § 180.950(a), (b), or (c), respectively, permitting the product to qualify as a minimum-risk pesticide under the US EPA's FIFRA § 25(b).

In some embodiments, the first tablet and the second tablet further comprise an about 0.1% to about 40% by weight of at least one excipient selected from binders, fillers, flow aids, or disintegrants that are inert under 40 C.F.R. § 180.950

Some embodiments of the present invention may include a method of delivering the biodegradable insect control tablet to the body of water. For example, a protective exterior, quick-dissolving sphere designed to protect the tablet as it is thrown into a larger body of water such as a lake. The protective exterior should cushion the impact of the tablet hitting the water but quickly dissolve so as to not undesirably delay the deployment of the tablet's contents into the body of water. This protective exterior could be another form of cellulose which is constructed to absorb the impact of the throw while having finer walls or being more porous or having a lattice structure to aid in its quick dissolution.

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Furthermore, to the extent that the term “includes” is used in either the detailed description or the claims, such term is intended to be inclusive in a manner similar to the term “comprising” as “comprising” is interpreted when employed as a transitional word in a claim.

### EXAMPLES

A dual-action tablet consisting of two segments divided by an adhesive layer. A first segment of the tablet consisting of an encapsulation of clove oil in β-cyclodextrin within a biodegradable matrix of cellulose. The first segment having a ratio of 1:1:3 of clove oil, β-cyclodextrin, and cellulose by weight. A second segment of the tablet consisting of a mixture of wheat flour, cork, and sodium bicarbonate. The second segment having a ratio of 2:1.5:1 of wheat flour, cork, and sodium bicarbonate.

A dual-action table consisting of an encapsulation of cedarwood oil in β-cyclodextrin within a biodegradable matrix of cellulose in a ratio of 1:1:2 of cedarwood oil, β-cyclodextrin, and cellulose by weight.

A first tablet consisting of an encapsulation of clove oil and orange oil in β-cyclodextrin and having cellulose comprise a biodegradable matrix. The first tablet having a ratio of 1.5:0.075:1.575:2.9 of clove oil, garlic oil, β-cyclodextrin, and cellulose by weight. A second tablet consisting of a mixture of lactose, wheat flour, cork, and sodium bicarbonate. The second tablet having a ratio of 3:2:1.5:1 of lactose, wheat flour, cork, and sodium bicarbonate.

A first tablet consisting of an encapsulation of clove oil and garlic oil in HPMC and having cellulose comprising a biodegradable matrix. The first tablet having a ratio of 1:0.1:1:1.9 of clove oil, garlic oil, HPMC, and cellulose. A second tablet consisting of a mixture of lactose, wheat flour, cedar sawdust, and sodium bicarbonate encapsulated and bound with a biodegradable matrix of cellulose. The second tablet having a ratio of 3:2:1.5:1:1 of lactose, wheat flour, cedar sawdust, sodium bicarbonate, and cellulose.

A dual-action tablet consisting of two segments divided by an adhesive layer. The first segment including the active ingredients clove oil and garlic oil. The first segment encasing the active ingredients in ß-cyclodextrin and including a biodegradable matrix comprised of cellulose. The second segment including the oviposition-influencing agents lactose, wheat flour, cork, and sodium bicarbonate. Wherein the dual-action tablet has a ratio of 1.5:0.075:1.575:2.9:3:2:1.5:1 by weight of clove oil, garlic oil, ß-cyclodextrin, cellulose, lactose, wheat flour, cork, and sodium bicarbonate. These segments may, individually, be equivalent to the previously mentioned first tablet and second tablet, wherein the segments are further designed to complement each other's shape while being separated by an adhesive layer.

A first tablet including the active ingredients clove oil and garlic oil encapsulated in ß-cyclodextrin and including a biodegradable matrix comprised of cellulose. The first tablet in a ratio of 0.9:0.1:9:20 by weight of clove oil, garlic oil, 62 -cyclodextrin, cellulose. The second tablet including the oviposition-influencing agents hay and cellulose. The second tablet in a ratio of 2:1 by weight of hay and cellulose. These tablets are further designed to complement each other's shape and might be connected by an adhesive layer to form a dual-action tablet.

A granule composed of at least one insecticidal oil encapsulated by β-cyclodextrin to create a granule which may be dispersed into a body of water.

An insecticidal oil encapsulated within an encapsulating agents and stored within a water-soluble pouch to be placed within a body of water wherein the water-soluble pouch will quickly dissolve, releasing its contents into the body of water.

A gel or emulsification compromised of at least one insecticidal oil to be placed within a body of water. The gel or emulsification including at least one encapsuling agent that facilitates the dispersal and desired rate of release of the at least one insecticidal oil into the body of water.

I claim:

1. A biodegradable insect control medium comprising:
a first tablet comprised of at least one encapsulation agent which encapsulates at least one active ingredient;
a second tablet comprised of at least one oviposition influencing agent;
wherein the at least one active ingredient includes at least one insecticidal oil;
wherein the first tablet is designed to release the at least one active ingredient into a body of water by the body of water's effect on the encapsulation agent;
wherein the second tablet is designed to release the at least one oviposition influencing agent into the body of water; and
wherein the first tablet and the second tablet are placed into the body of water so that the second tablet influences oviposition of female insects while the first tablet disrupts the species of insect's lifecycle by causing at least one desired effect from ovicide and larvicide.

2. The biodegradable insect control medium of claim 1, wherein at least one of the first tablet and the second tablet include at least one biodegradable matrix.

3. The biodegradable insect control medium of claim 2, wherein at least one of the encapsulating agent of the first tablet serves as the biodegradable matrix for the first tablet.

4. The biodegradable insect control medium of claim 2, wherein at least one of the first tablet and the second tablet are manufactured to provide a gradual release of the at least one active ingredient and the at least one oviposition influencing agent over a period, wherein the sustained release of at least one of the first tablet and the second tablet is achieved by the encapsulating agent's and the biodegradable matrix's interaction with the body of water.

5. The biodegradable insect control medium of claim 2, wherein the molar ratio of at least one active ingredient to at least one encapsulation agent within the first tablet ranges from about 1:0.1 to about 1:25.

6. The biodegradable insect control medium of claim 5, wherein the at least one active ingredient contributes between about 0.1% to about 10% of the total tablet weight of the first tablet and the at least one oviposition influencing agent contributes between about 5% to about 99% of the total tablet weight of the second tablet.

7. The biodegradable insect control medium of claim 6, wherein the first tablet has a ratio of active ingredients to encapsulating agents to biodegradable matrixes of about 1:5:10 to about 1:10:25 by weight, and the second tablet has a ratio of about 1:2 to about 4:1 of oviposition influencing agents to biodegradable matrixes by weight.

8. The biodegradable insect control medium of claim 7, wherein at least two active ingredients are insecticidal oils that are selected to produce a synergistic blend due to at least one of the active ingredient's effect as acting as at least one of an ovicide and a larvicide.

9. The biodegradable insect control medium of claim 8, wherein the first tablet includes clove oil and garlic oil that are selected as insecticidal oils and are in a ratio from about 10:1 to about 20:1.

10. The biodegradable insect control medium of claim 1, wherein the first tablet and the second tablet are integrated into a combined tablet.

11. The biodegradable insect control medium of claim 10, further comprising an adhesive layer that is water-soluble and binds the first tablet and the second tablet until the combined tablet is placed within the body of water, dissolving the adhesive layer.

12. The biodegradable insect control medium of claim 1, wherein the active ingredient release rate is between 0.01 μg/mL and 50 μg/mL daily when measured using at least one release rate analytic method.

13. The biodegradable insect control medium of claim 1, wherein the first tablet and the second tablet further comprise about 0.1% to about 40% by weight of at least one excipient selected from binders, fillers, flow aids, and disintegrants that are inert under at least one of 40 C.F.R. § 180.950, 40 C.F.R. § 152.25(f), and FIFRA § 25(b).

14. The biodegradable insect control medium of claim 13, wherein the inert ingredients reduce the amount of excess active ingredients within the body of water by at least one of absorption and adsorption.

15. A biodegradable insect control medium comprising:
at least two delivery mediums;
wherein at least one of the delivery mediums is a first medium comprised of at least one encapsulation agent which encapsulates at least one active ingredient;
wherein at least one of the delivery mediums is a second medium comprised of at least one oviposition influencing agent;
wherein the at least one active ingredient includes at least one insecticidal oil;
wherein the first medium is designed to release the at least one active ingredient into a body of water by the body of water's effect on the encapsulation agent;
wherein the second medium is designed to release the at least one oviposition influencing agent into the body of water; and
wherein the first medium and the second medium are placed into the body of water so that the second medium influences oviposition of female insects while the first medium disrupts the species of insect's lifecycle by causing at least one desired effect from ovicide and larvicide.

16. The biodegradable insect control medium of claim 15, wherein at least one of the delivery mediums includes at least one biodegradable matrix.

17. The biodegradable insect control medium of claim 15, further comprising at least one additional delivery medium comprised of at least one additional encapsulating agent which encapsulates at least one additional active ingredient or at least one additional oviposition influencing agent.

18. The biodegradable insect control medium of claim 17, wherein at least one of the delivery mediums has a different at least one of encapsulating agent, active ingredient, and oviposition influencing agent than other delivery mediums having the same type.

19. The biodegradable insect control medium of claim 18, wherein all delivery mediums comprise segments of a single, combined delivery medium.

20. The biodegradable insect control medium of claim 19, further comprising an adhesive layer which binds the single, combined delivery medium until the single, combined delivery medium is placed within the body of water wherein the adhesive layer dissolves allowing the segments of delivery mediums to disperse through the body of water.

21. The biodegradable insect control medium of claim 15, wherein at least one of the delivery mediums containing the at least one active ingredient has an active ingredient release rate between 0.01 μg/mL and 50 μg/mL daily when measured using at least one release rate analytic method.

22. The biodegradable insect control medium of claim 15, wherein the delivery mediums containing the at least one active ingredient and the delivery mediums containing the at least one oviposition influencing agent further comprise about 0.1% to about 40% by weight of at least one excipient selected from binders, fillers, flow aids, and disintegrants that are inert under at least one of 40 C.F.R. § 180.950, 40 C.F.R. § 152.25(f), and FIFRA § 25(b).

23. The biodegradable insect control medium of claim 22, wherein the inert ingredients reduce the amount of excess active ingredients within the body of water by at least one of absorption and adsorption.

24. The biodegradable insect control medium of claim 15, wherein the first medium comprises at least two active ingredients that are insecticidal oils that are selected to produce a synergistic blend due to their effects as acting as at least one of an ovicide and a larvicide.

25. A biodegradable insect control medium comprising:
a delivery medium comprised of at least one encapsulation agent which encapsulates at least one active ingredient;
wherein the at least one active ingredient includes at least one insecticidal oil;
wherein the delivery medium is designed to gradually release the at least one active ingredient into a body of water by the body of water's effect on the encapsulation agent; and
wherein the delivery medium is placed into the body of water so that the delivery medium disrupts the species of insect's lifecycle by causing at least one desired effect from ovicide and larvicide.

26. The biodegradable insect control medium of claim 25, wherein the delivery medium includes at least one biodegradable matrix.

27. The biodegradable insect control medium of claim 25, wherein the molar ratio of at least one active ingredient to at least one encapsulation agent within the delivery medium ranges from about 1:0.1 to about 1:25.

28. The biodegradable insect control medium of claim 25, wherein the delivery medium comprises at least two active ingredients that are insecticidal oils that are selected to produce a synergistic blend due to their effects as acting as at least one of an ovicide and a larvicide.

29. The biodegradable insect control medium of claim 25, wherein the delivery further comprises about 0.1% to about 40% by weight of at least one excipient selected from binders, fillers, flow aids, and disintegrants that are inert under at least one of 40 C.F.R. § 180.950, 40 C.F.R. §152.25(f), and FIFRA § 25(b).

30. The biodegradable insect control medium of claim 29, wherein the inert ingredients reduce the amount of excess active ingredients within the body of water by at least one of absorption and adsorption.
